(19) United States
(12) Patent Application Publication
(10) Pub. No.: US 2007/0115339 A1
(43) Pub. Date: May 24, 2007

(54) Image forming device and method of correcting image to be formed

(75) Inventors: Yoshiki Matsuzaki, Kanagawa (JP); Ryo Ando, Kanagawa (JP); Kozo Tagawa, Kanagawa (JP); Tsutomu Udaka, Kanagawa (JP); Kenji Koizumi, Kanagawa (JP); Toshiki Matsui, Kanagawa (JP); Toshio Hisamura, Kanagawa (JP); Yasuhiro Arai, Kanagawa (JP); Kazuhiro Hama, Kanagawa (JP); Hiroshi Ono, Kanagawa (JP); Hideki Kashimura, Kanagawa (JP); Kohei Shioya, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/485,292

(22) Filed: Jul. 13, 2006

(30) Foreign Application Priority Data
Nov. 24, 2005 (JP) 2005-339305

(51) Int. Cl. G03G 15/01; B41J 2/385; G01D 15/06

(52) U.S. Cl. 347/118

(57) ABSTRACT

An image forming device includes a rotating polygon mirror and a correcting component that corrects misregistration of an image region in a predetermined direction. The correcting component carries out the correction by correcting image data used in modulating light beams reflected and deflected by any one reflecting surface among plural reflecting surfaces provided at the rotating polygon mirror, where the light beams scann a body-to-be-illuminated in the predetermined direction, correcting image data by each data unit used in modulating light beams which are reflected and deflected at the same reflecting surface, and correcting image data in accordance with a misregistration amount in the predetermined direction of the image region formed on the body-to-be-illuminated by the light beams which are reflected and deflected, where the misregistration amount is measured in advance for each reflecting surface of the rotating polygon mirror.

### BACKGROUND

1. Technical Field

The present invention relates to an image forming device and a method of correcting an image to be formed, and in particular, to an image forming device which, by reflecting and deflecting light beams, which are modulated by using image data, by a reflecting surface among plural reflecting surfaces provided at a rotating polygon mirror, scans the light beams on a body-to-be-illuminated thereby forming an image on the body-to-be-illuminated, and to a method of correcting an image to be formed which can be applied to the image forming device.

2. Related Art

There are conventionally known image forming devices which, by reflecting and deflecting light beams, which are modulated in accordance with an image to be formed, by a polygon mirror and scanning (main scanning) the light beams on an image carrier, form an electrostatic latent image, and, by transferring a toner image, which is obtained by developing the formed electrostatic latent image, onto a recording material, form an image on the recording material. Further, there are also known color image forming devices which are structured so as to have plural image forming sections having optical scanning devices and image carriers, and the individual image forming sections independently form toner images of respective colors on the different image carriers, and by transferring the toner images of the respective colors onto the same recording material such that the toner images are superposed one on top of another, forms a color image on the recording material.

In a case in which light beams are reflected and deflected and scanned by a polygon mirror, misregistration of the image region in the main scanning direction per scan line (called “jitter”) arises due to variation within the tolerance of the respective reflecting surfaces of the polygon mirror, fluctuations in the rotating speed of the polygon mirror, and, in addition thereto, aberration of the optical systems disposed before and after the polygon mirror, and the like. Such misregistration of the image region per scan line (jitter) appears as fluctuations in the magnification in the main scanning direction which are such that the amount of misregistration is small at the start-of-scanning side and the amount of misregistration becomes greater at the end-of-scanning side. The period of this fluctuation in magnification is one rotation of the polygon mirror. The aforementioned misregistration of the image region (jitter) can be confirmed visually, in a monochrome image, as fluctuations of the image which become larger the closer toward the end portion at the end-of-scanning side (variation in the position of the end portion of the image at the end-of-scanning side), and, in a color image, as color misregistration or color non-uniformity due to main scanning magnification fluctuations of the images of the respective colors.

### SUMMARY

According to an aspect of the invention, there is provided an image forming device including a rotating polygon mirror and a correcting component that corrects misregistration of an image region in a predetermined direction. The correcting component carries out the correction by correcting image data used in modulating light beams reflected and deflected by any one reflecting surface among plural reflecting surfaces provided at the rotating polygon mirror, where the light beams scann a body-to-be-illuminated in the predetermined direction, correcting image data by each data unit used in modulating light beams which are reflected and deflected at the same reflecting surface, and correcting image data in accordance with a misregistration amount in the predetermined direction of the image region formed on the body-to-be-illuminated by the light beams which are reflected and deflected, where the misregistration amount is measured in advance for each reflecting surface of the rotating polygon mirror.

### BRIEF DESCRIPTION OF THE DRAWINGS

An exemplary embodiment of the present invention will be described in detail based on the following figures, wherein:

FIG. 1 is a schematic structural diagram of a color image forming device relating to an exemplary embodiment of the present invention;

FIG. 2 is a perspective view showing the schematic structure of a scanning/exposing section;

FIGS. 3A through 3C are plan views showing periodic misregistration (jitter) of an image region along a main scanning direction at each scan line;

FIG. 3D is a plan view showing an example of illuminating positions of a large number of light beams emitted from a surface light-emitting laser array (VCSEL);

FIG. 4 is a functional block diagram of a control section;

FIG. 5 is a flowchart showing contents of correction value setting processing;

FIG. 6A is an image diagram showing an example of a positional relationship between detecting units and patterns for misregistration detection;

FIG. 6B is an image diagram showing an example of a pattern formed by a specific reflecting surface;

FIG. 6C is an image diagram showing an example of positional misregistration of respective patterns formed by respective reflecting surfaces;

FIGS. 7A through 7C are image diagrams showing changes in the length of an image region along a main scanning direction due to the addition/deletion of pixels;

FIG. 8 is a flowchart showing contents of image correcting processing which is executed for each color material color;

FIG. 9 is an image diagram showing an example of misregistration of an image region at each scan line in an image at which correction relating to the present invention has not been carried out;

FIG. 10 is an image diagram showing an example of image regions at respective scan lines in a case in which correction relating to the present invention is carried out on the image shown in FIG. 9; and

Figs. 11A through 11C are image diagrams for explaining an example of correcting SOS side end portion positions of image regions by applying the present invention.

### DETAILED DESCRIPTION

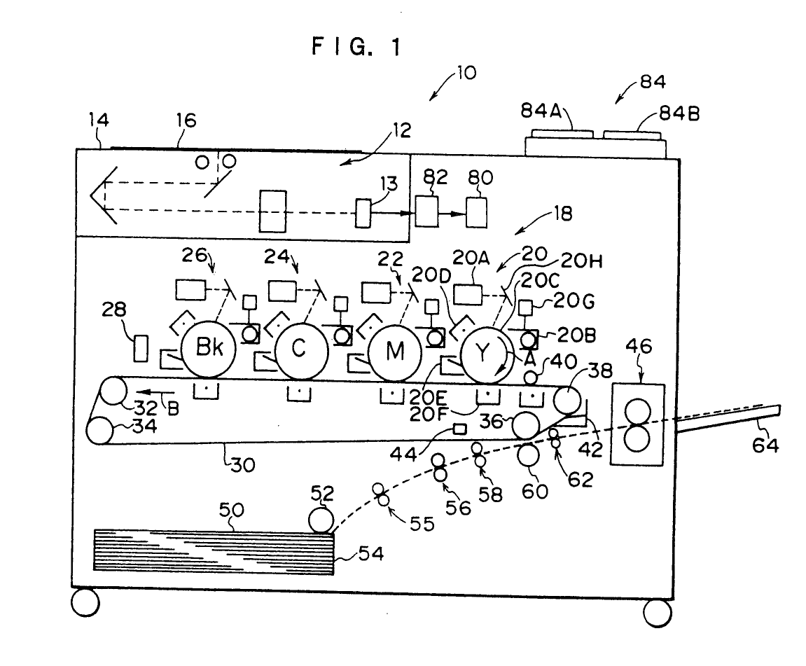

An exemplary embodiment of the present invention will be described in detail hereinafter with reference to the drawings. A color image forming device 10 relating to the present exemplary embodiment is shown in FIG. 1. The color image forming device 10 has a document reader 12 which exposes/scans a document 16 placed at a predetermined position on a platen glass 14, decomposes the image of the document 16 into respective R, G, B color components and reads them by a CCD sensor 13, and outputs R, G, B image signals; and an image forming device 18 which forms a color image onto a sheet 50 on the basis of the image signals obtained by the document reader 12 reading the image of the document 16. Note that the color image forming device 10 corresponds to the image forming device relating to the present invention.

The image forming device 18 has an image accumulating section 82 which converts the R, G, B image signals obtained by reading by the CCD sensor 13 into multi-value image data for each of the color material colors of Y, M, C, K (image data which expresses the density of each color material color of Y, M, C, K of each pixel by multi-value data of plural bits (e.g., 8 bits)), and accumulates the image data; and a control section 80 which is structured so as to include a CPU, a ROM, a RAM used as a work memory, and a non-volatile storage component formed from an EEPROM, a flash memory, or the like, and which controls the overall processings at the color image forming device 10. A correction value setting program for carrying out correction value setting processing and an image correcting program for carrying out image correcting processing, which will be described later, are stored in advance in the non-volatile storage component. Moreover, an operation section 84 is provided on the top surface of the color image forming device 10. The operation section 84 is structured to include a display 84A which displays messages and the like, and a keyboard 84B for an operator to input various types of commands and the like. The operation section 84 is connected to the control section 80.

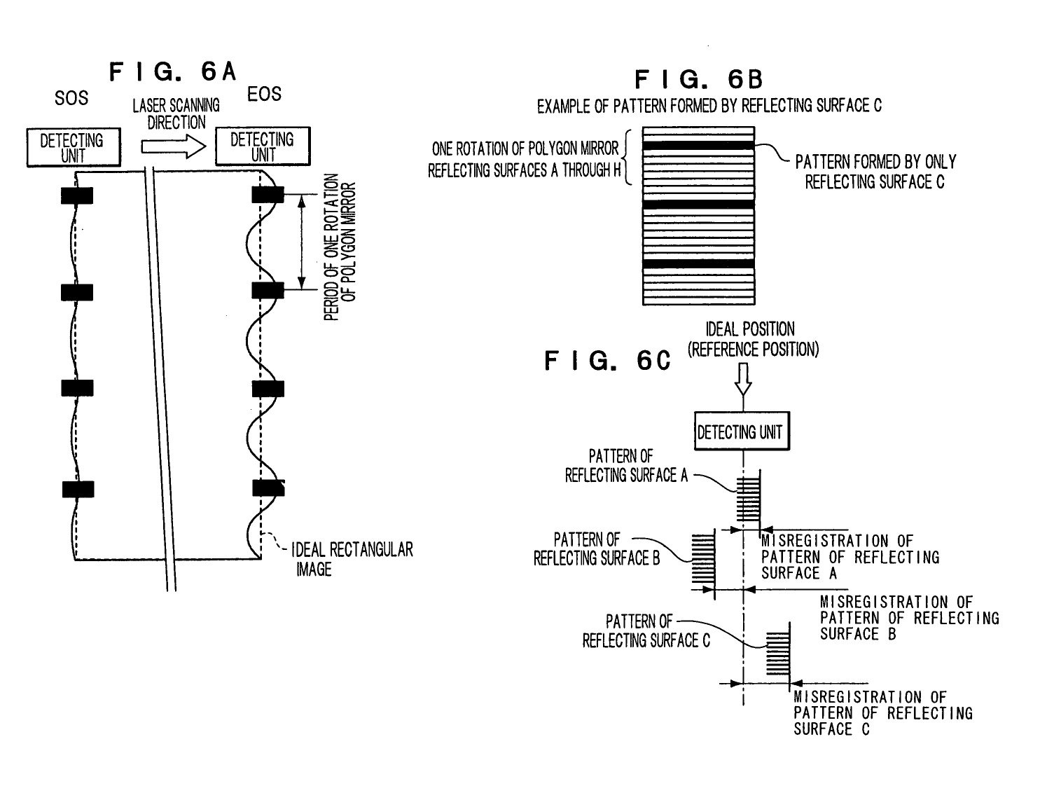

The image forming device 18 has an endless intermediate transfer belt 30 trained about driving rollers 32, 34, 36, 38. The intermediate transfer belt 30 is a dielectric whose volume resistance is adjusted by carbon for electrostatic transfer of toner images, and is conveyed in a circulating manner in a predetermined direction (the direction of arrow B in FIG. 1 between the driving rollers 32, 38) by the driving rollers 32, 34, 36, 38. An image forming section 20 which forms a Y color toner image on the intermediate transfer belt 30, an image forming section 22 which forms an M color toner image on the intermediate transfer belt 30, an image forming section 24 which forms a C color toner image on the intermediate transfer belt 30, an image forming section 26 which forms a K color toner image on the intermediate transfer belt 30, and a pattern detecting section 28 for detecting a pattern for misregistration detection which is formed on the intermediate transfer belt 30, are provided above the intermediate transfer belt 30 in that order along the direction of arrow B in FIG. 1. The pattern detecting section 28 is structured (refer to FIG. 6A as well) such that a detecting unit, which has light-emitting elements and light-receiving elements formed from a CCD and which is for optically detecting the pattern for misregistration detection formed on the intermediate transfer belt 30, is disposed at each of both end portions (an SOS (Start-of-Scan) position and an EOS (End-of-Scan) position) along the transverse direction of the intermediate transfer belt 30 (the main scanning direction).

The image forming section 20 has a photosensitive drum 20C which is substantially cylindrical, and which can rotate in the direction of arrow A in FIG. 1 around an axis, and which is disposed such that the outer peripheral surface thereof contacts the intermediate transfer belt 30. At the outer periphery of the photosensitive drum 20C, a charger 20D, which charges the outer peripheral surface of the photosensitive body 20C to a predetermined potential, is provided, and a scanning/exposing section 20A is provided at the downstream side of the charger 20D along the direction of arrow A in FIG. 1.

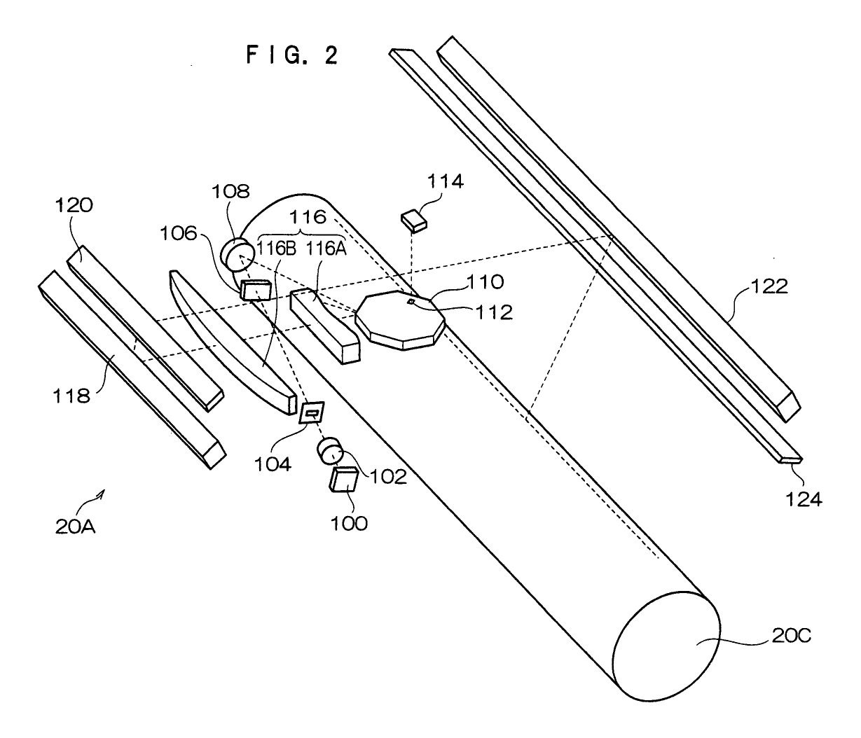

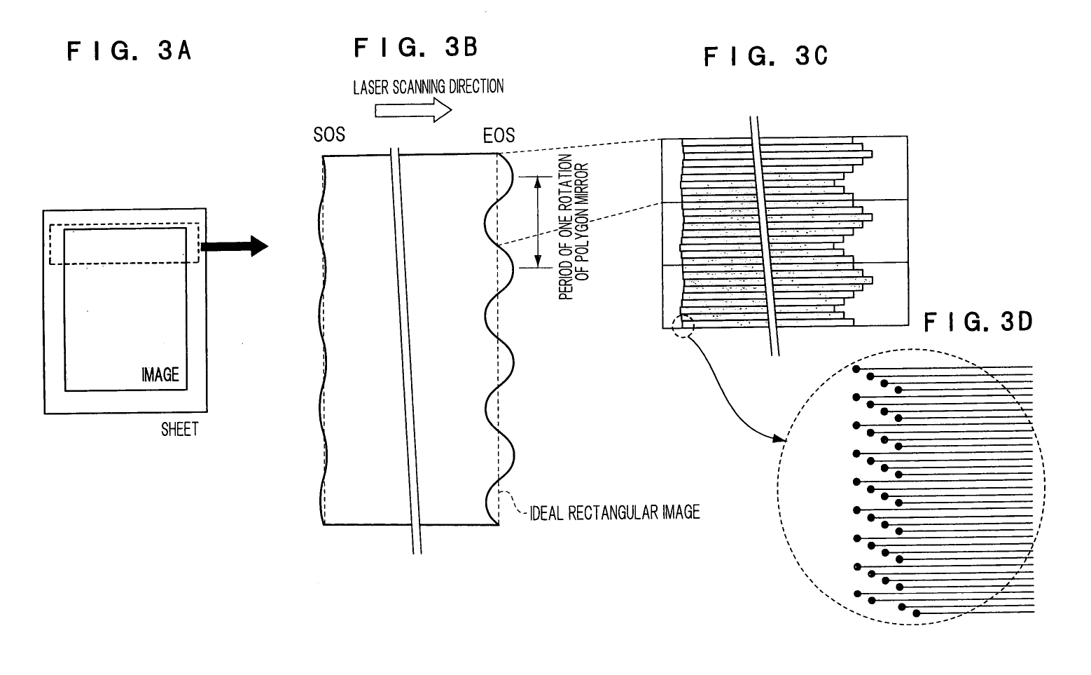

As shown in FIG. 2, the scanning/exposing section 20A has a surface emitting laser array (VCSEL) 100 which serves as a multibeam light source which can emit plural light beams, and at which are formed a large number (32 in the present exemplary embodiment) of light-emitting portions which emit light beams of a substantially Gaussian distribution. The light beams emitted from the VCSEL 100 are deflected in the main scanning direction by a scanning optical system which will be described later, and thereafter, are illuminated onto the photosensitive body 20C which is a body-to-be-scanned. The peripheral surface of the photosensitive body 20C is thereby scanned along a direction (the main scanning direction) parallel to the axis of the photosensitive body 20C. Image data for printing the color material color Y (binary image data) is supplied to the scanning/exposing section 20A from the control section 80. The laser beams emitted from the VCSEL 100 are respectively modulated in accordance with the image data for printing which is supplied from the control section 80, and subscanning is carried out due to the photosensitive body 20C rotating. An electrostatic latent image of the image of the color material color Y is thereby formed on the charged portion on the peripheral surface of the photosensitive body 20C. Further, the respective light-emitting portions formed at the VCSEL 100 are disposed such that the positions, along the subscanning direction, of the light beams emitted from the individual light-emitting portions do not overlap one another. Moreover, as shown in FIG. 3D, with regard to the light beams emitted from the respective light-emitting portions, the illuminated positions thereof along the main scanning direction on the photosensitive body 20C are also misaligned, but this misregistration is corrected by relatively changing the modulation start timings of the light beams emitted from the individual light-emitting portions at the time of image formation.

A collimator lens 102, a slit 104, a cylindrical lens 106, and a mirror 108 are disposed in that order at the light beam emitting side of the VCSEL 100. The collimator lens 102 is disposed such that the interval between the collimator lens 102 and the VCSEL 100 coincides with the focal length of the collimator lens 102. The light beams emitted from the VCSEL 100 are made into a bundle of substantially parallel light by the collimator lens 102, and are shaped by the slit 104, and thereafter, are incident on the cylindrical lens 106. The cylindrical lens 106 has power only the subscanning direction, and converges the incident light beams as a line image, which is long and thin in the main scanning direction on the reflecting surface of a polygon mirror 110 which will be described later, and makes the light incident on the mirror 108.

The polygon mirror 110 (corresponding to the rotating polygon mirror relating to the present invention) is disposed at the exiting side of the light beams reflected at the mirror 108. The polygon mirror 110 is shaped as a regular polygon column (a regular octagon in the present exemplary embodiment) at which plural reflecting surfaces (deflecting surfaces) of the same surface width are formed at the side surface portions thereof, and is rotated at a uniform angular velocity around a central axis by a driving component. The light beams reflected at the half-mirror 108 are reflected by the polygon mirror 110, and are deflected/scanned in the main scanning direction as the polygon mirror 110 rotates. A reflecting member 112 is affixed to the top surface of the polygon mirror 110. A rotational position detecting sensor 114, which has a light-emitting element and a light-receiving element, is provided above the polygon mirror 110. The rotational position detecting sensor 114 is disposed at a position which is directly above the affixed position of the reflecting member 112 at the time when the polygon mirror 110 is at a specific rotational angle, and is connected to the control section 80, and outputs to the control section 80 a signal which is synchronous with the rotation of the polygon mirror 110 (a signal in which a predetermined period level changes each time the polygon mirror 110 comes to the specific rotational angle). Instead of the rotational position detecting sensor 114 and the reflecting member 112, the reflecting surface may be detected by a rotary encoder which is mounted to the polygon mirror 110.

An fθ lens 116, which is formed from a group of two lenses 116A, 116B, is disposed at the light beam exiting side of the polygon mirror 110. The fθ lens 116 images the light beam, which is deflected/scanned by the polygon mirror 110, onto the peripheral surface of the photosensitive body 20C in the main scanning direction as a light spot, and functions to move this light spot at a substantially uniform velocity in the main scanning direction on the peripheral surface of the photosensitive body 20C. A first cylindrical mirror 118, a planar mirror 120, a second cylindrical mirror 122, and a window 124 are disposed in that order at the light beam exiting side of the fθ lens 116. The light path of the light beam which has passed through the fθ lens 116 is bent in a substantial U-shape by the first cylindrical mirror 118 and the planar mirror 120. The light beam is further reflected at the second cylindrical mirror 122, and thereafter, passes through the window 124 and is illuminated onto the peripheral surface of the photosensitive body 20C which is disposed beneath the window 124.

The first cylindrical mirror 118 and the second cylindrical mirror 122 have power in the subscanning direction. By setting the reflecting surfaces of the polygon mirror 110 and the photosensitive body 20C in a substantially conjugate relationship, the first cylindrical mirror 118 and the second cylindrical mirror 122 function to correct the misregistration (surface tilting) of the light beam illuminated positions along the subscanning direction on the peripheral surface of the photosensitive body 20C which is caused by variation within the tolerance of the reflecting surfaces of the polygon mirror 110. Further, the curvatures, in the subscanning direction, of the collimator lens 102, the cylindrical lens 106, the first cylindrical mirror 118, and the second cylindrical mirror 122 are set such that there is a telecentric relationship in which the intervals between the light beams along the subscanning direction on the photosensitive body 20C, and the intervals between the light beams along the subscanning direction at a position several millimeters away from the photosensitive body 20C, are equal.

On the other hand, a developing device 20B, a transfer device 20F, and a cleaning device 20E are provided in that order at the downstream side, along the direction of arrow A in FIG. 1, of the laser beam illuminating position onto the outer peripheral surface of the photosensitive body 20C. Y color toner is supplied to the developing device 20B from a toner supplying section 20G, and the developing device 20B develops, by the Y color toner, the electrostatic latent image formed by the scanning/exposing section 20A, so as to form a Y color toner image. The transfer device 20F is disposed so as to oppose the outer peripheral surface of the photosensitive body 20C, with the intermediate transfer belt 30 therebetween. The transfer device 20F transfers the Y color toner image, which is formed on the outer peripheral surface of the photosensitive body 20C, onto the outer peripheral surface of the intermediate transfer belt 30. The toner, which remains on the outer peripheral surface of the photosensitive body 20C after the transfer of the toner image, is removed by the cleaning device 20E.

Because the structures of the image forming sections 22, 24, 26 are the same as the structure of the image forming section 20 as is clear from FIG. 1 (although the color material colors of the formed toner images are respectively different), description thereof is omitted. The image forming sections 20, 22, 24, 26 transfer the formed toner images of the respective colors such that they are superposed one on top of another on the outer peripheral surface of the intermediate transfer belt 30. In this way, a full-color toner image is formed on the outer peripheral surface of the intermediate transfer belt 30. Further, an attracting roller 40, a cleaning device 42, and a reference position detecting sensor 44 are provided in that order along the path of circulation of the intermediate transfer belt 30, at the upstream side of the image forming section 20 in the direction of circulation of the intermediate transfer belt 30. The attracting roller 40 maintains the surface potential of the intermediate transfer belt 30 at a predetermined potential, in order to make the toner attractability of the intermediate transfer belt 30 good. The cleaning device 42 removes toner from the intermediate transfer belt 30. The reference position detecting sensor 44 detects a predetermined reference position on the intermediate transfer belt 30 (e.g., that a mark formed from a seal or the like which is highly light-reflective is applied).

On the other hand, a tray 54, which accommodates a large number of the sheets 50 in a stacked state, is provided beneath the position where the intermediate transfer belt 30 is disposed. The sheet 50 which is accommodated in the tray 54 is pulled-out from the tray 54 as a pull-out roller 52 rotates, and is conveyed to a transfer position (the position where the driving roller 36 and a transfer roller 60 are disposed) by conveying roller pairs 55, 56, 58. The transfer roller 60 is disposed so as to oppose the driving roller 36 with the intermediate transfer belt 30 therebetween. Due to the sheet 50, which is conveyed to the transfer position, being sandwiched between the transfer roller 60 and the intermediate transfer belt 30, the full-color toner image formed on the outer peripheral surface of the intermediate transfer belt 30 is transferred. The sheet 50, onto which the toner image is transferred, is conveyed by a conveying roller pair 62 to a fixing device 46, and after fixing processing is carried out by the fixing device 46, the sheet 50 is discharged to a catch tray 64.

Operation of the present exemplary embodiment will be described next. In a structure, such as the color image forming device 10 relating to the present exemplary embodiment, in which an image is formed on a photosensitive body by reflecting and deflecting light beams by a polygon mirror and scanning them on the photosensitive body, minute differences in the scanning speed of the light beams reflected at the respective reflecting surfaces of the polygon mirror (fluctuations in the main scanning direction magnification) arise mainly due to variation within the tolerance of the respective reflecting surfaces and fluctuations in the rotating speed of the polygon mirror. As shown in FIGS. 3A through 3C, misregistration (jitter) of the image region along the main scanning direction at each scan line arises at a period which is one rotation of the polygon mirror.

Fluctuations in the rotating speed of the polygon mirror and variation within the tolerance of the respective reflecting surfaces, which are main causes of jitter, are suppressed to the limit by increasing the accuracy of the rotational driving of the polygon mirror, increasing the accuracy of manufacturing the polygon mirror, and the like. However, in a case in which the interval between the SOS side position and the EOS side position (the length of the image region along the main scanning direction) is 297 mm for example, positional misregistration of the image end portion along the main scanning direction is about 10 μm at the SOS side position and about 20 μm at the EOS side position. In a case in which the structure of the rotating/driving section of the polygon mirror is simplified or the manufacturing accuracy of the polygon mirror is reduced in order to cut costs, the positional misregistration at the end portion of the image along the main scanning direction does not change all that much at the SOS side position (about 10 to 15 μm), but worsens to about 40 to 60 μm at the EOS side position.

On the other hand, at each of the image forming sections 20, 22, 24, 26 of the color image forming device 10 relating to the present exemplary embodiment, 32 lines are scanned/exposed all at once in one main scan, due to the 32 light beams emitted from the VCSEL 100 of the scanning/exposing section 20A being illuminated simultaneously onto the photosensitive body 20C. For example, in a case in which the resolution in the subscanning direction of the formed image is 2400 dpi, the interval of the lines along the subscanning direction on the photosensitive body 20C is 10.58 μm (25.4 mm/2400 dpi). Therefore, if the number of reflecting surfaces of the polygon mirror 110 is “8” , the period of the aforementioned jitter along the subscanning direction is 2.7 mm. Cases in which the techniques of aforementioned JP-A No. 4-373253, JP-A No. 2002-200784, and JP-B No. 6-57040 are applied under this condition in order to correct jitter will be considered.

The technique disclosed in JP-A No. 4-373253 presupposes a multiple system in which images of respective colors are formed in order on a single photosensitive drum, and the formed images of the respective colors are superposed one on top of another in order on an intermediate transfer body. In a multiple-system image forming device, the rotational driving of the photosensitive body and the rotational driving of the polygon mirror are synchronized. Here, in the multiple system, fluctuations in the moving speed of the intermediate transfer body arise due to a cleaning blade and a secondary transfer roller contacting and moving away from the intermediate transfer body, and there is the need to synchronize the rotational speed of the photosensitive body and the moving speed of the intermediate transfer body in order to suppress color misregistration. In addition, in order to synchronize the rotational driving of the photosensitive body with the rotational driving of the polygon mirror, there is the need to add new structures which realize functions such as detecting the phase difference, correcting the detected phase difference, and the like. The structure of the device becomes complex, and the cost thereof increases. Further, under the conditions mentioned in JP-A No. 4-373253 of 400 dpi, the number of reflecting surfaces of the polygon mirror being 8, and the number of light beams being 1, the period of the jitter along the subscanning direction is 0.5 mm which is short. However, if the period of the jitter along the subscanning direction becomes 2.7 mm which is long as in the color image forming device 10 relating to the present exemplary embodiment, the fluctuations in the speeds of the photosensitive body and the intermediate transfer body during one period of the jitter also become great, thereby leading to further complicating of the structure and a further increase in costs. Moreover, as mentioned previously, although the technique disclosed in JP-A No. 4-373253 can suppress color misregistration, it cannot correct variation of the positions of the image end portions, and therefore, there is the problem that these can be confirmed visually as a deterioration in image quality.

In the techniques disclosed in JP-A No. 2002-200784 and JP-B No. 6-57040, frequency modulation of a video clock is carried out by using a clock signal of frequency which is two or more times greater than the video clock, such that fluctuations in the scanning speed of light beams are offset. In this way, fluctuations in the main scanning direction magnification per color are corrected. For example, under conditions such as 600 dpi, the number of light beams being 2, and the like, it suffices for the frequency of video clock to be about 20 to 30 MHz. In contrast, under conditions such as 2400 dpi and the number of light beams being 32 as in the case of the color image forming device 10 relating to the present exemplary embodiment, the frequency of the video clock greatly increases to about 130 to 140 MHz (in order to satisfy the need for higher resolution and improvement in processing capacity). Therefore, if an attempt is made to carry out frequency modulation of a video clock by using a clock signal of a frequency which is two or more times greater than the video clock whose frequency has become high, there is the problem of leading to a great increase in costs. Moreover, in order to correct, in increments of 10 μm, the position and the length of an image region whose length along the main scanning direction is 297 mm, the frequency of the video clock must be changed at a resolution of about 30 ppm (=10 μm/297 mm), and it is extremely difficult to carry out the above-described control at the aforementioned resolution on frequencies of high-frequency video clocks of 100 MHz or more. Still further, as mentioned previously, the techniques disclosed in JP-A No. 2002-200784 and JP-B No. 6-57040 are techniques which carry out correction under the assumption that the misregistration amount of the image region of each color progresses constantly as is during formation of the image. In order to correct misregistration of an image region, whose misregistration amount changes dynamically in the midst of the formation of a single image, by the techniques of JP-A No. 2002-200784 and JP-B No. 6-57040, control must be carried out so that the frequency of the video clock varies per scan line, but such control is impractical from the standpoint of response as well.

On the basis of the above, in the present exemplary embodiment, by switching the modulation start timings of the light beams in each main scan per each of the reflecting surfaces of the polygon mirror 110, the variation in the end portion position of the image region per scan line at the SOS side is corrected. By carrying out addition or deletion of pixels with respect to the data used in modulating the light beams in the main scan of each time (data of 32 main scan lines, which is the “unit data” in the present invention), and switching, per each of the reflecting surfaces of the polygon mirror 110, the number of pixels which are to be added or deleted, the variation in the length of the image region per scan line (i.e., variation in the end portion position of the image region per scan line at the EOS side) is corrected. Details thereof will be described hereinafter.

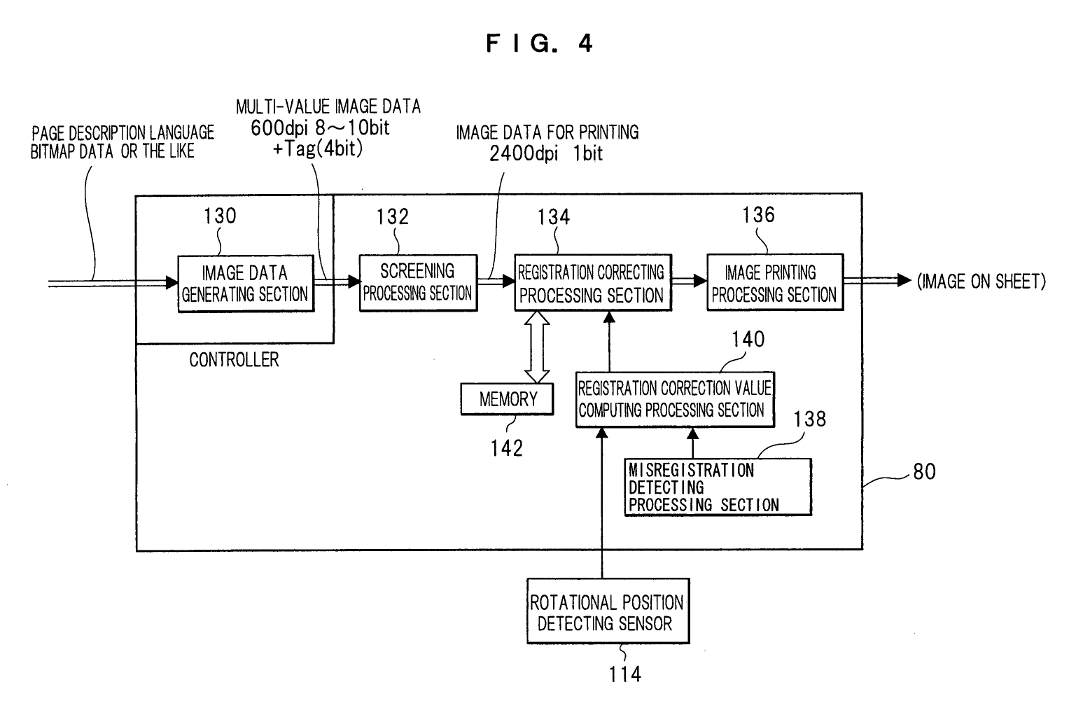

As shown in FIG. 4, when, as data of the image to be printed on the sheet 50, the control section 80 of the color image forming device 10 receives data described in a page description language from a host computer connected via a network such as a LAN or the like, or bitmap data is inputted to the control section 80 from the document reader 12, the control section 80 converts the data into multi-value image data for each of the color material colors of Y, M, C, K by an image data generating section 130 (image data of a relatively low resolution (e.g., 600 dpi) which expresses the densities of each of the color material colors of Y, M, C, K of each of the pixels in plural bits (e.g., 8 bits)). This multi-value image data is inputted to a screening processing section 132, and the screening processing section 132 carries out screening processing on the multi-value image data so as to convert it into image data for printing (binary image data of each of the color material colors of Y, M, C, K which are relatively high resolution (e.g., 2400 dpi) and express the densities of the individual pixels in the multi-value image data by plural binary pixels). This image data for printing is subjected to registration correcting processing (to be described later) by a registration correcting processing section 134, and is supplied to an image printing processing section 136. In accordance with the supplied image data for printing, the image printing processing section 136 modulates the light beams emitted from the VCSELs 100 of the scanning/exposing sections 20A of the individual image forming sections 20, 22, 24, 26, and controls the operations of the individual image forming sections 20, 22, 24, 26, thereby causing formation of a color image.

Here, in order to correct the variation of the end portion position of the image region per scan line at the SOS side and the EOS side, a misregistration detecting processing section 138, a registration correction value computing processing section 140, the aforementioned registration correcting processing section 134, and a memory 142 for storing correction values, are provided at the control section 80 relating to the present exemplary embodiment.

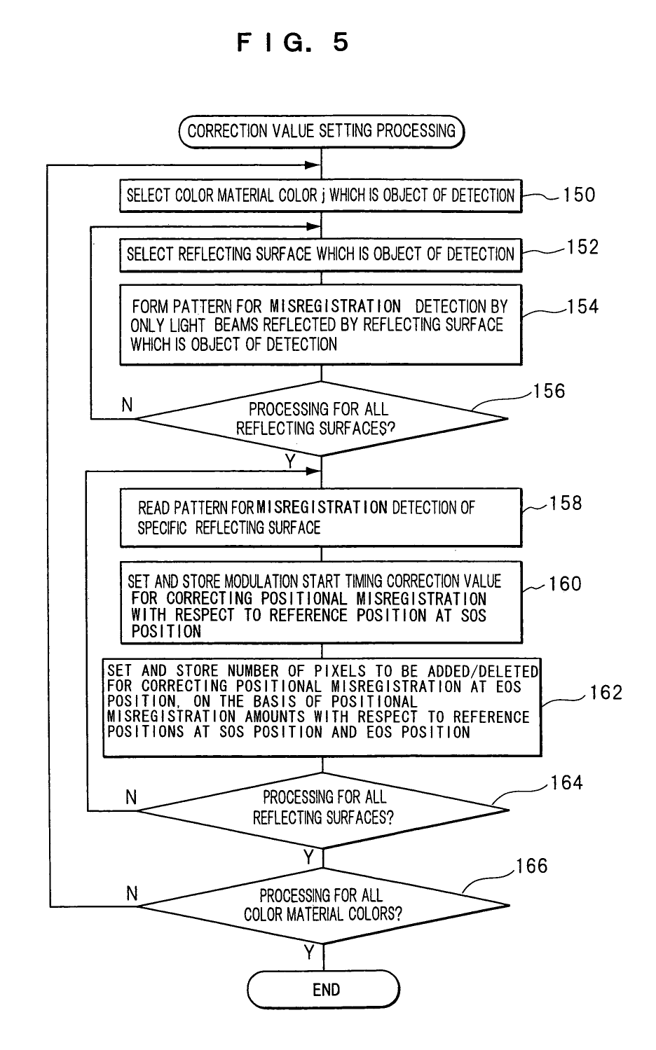

Hereinafter, first, correction value setting processing, which is realized by the control section 80 executing a correction value setting program, will be described with reference to FIG. 5 as processing corresponding to the misregistration detecting processing section 138 and the registration correction value computing processing section 140. This correction value setting processing is executed at the time when the color image forming device 10 is manufactured, at the time when the color image forming device 10 is set-up, and at times when the structural parts of the color image forming device 10 are replaced (e.g., when the photosensitive body 20C is replaced, when the scanning/exposing section 20A is replaced, when electrical circuit parts relating to the rotational driving of the polygon mirror 110 are replaced, and the like). Other than the aforementioned times, the correction value setting processing is also executed in cases in which, for example, the accumulated working time, from the time that the correction value setting processing was last executed, has reached a predetermined time.

In the correction value setting processing, first, in step 150, a color material color j, which is the object of misregistration detection, is selected. In next step 152, among the reflecting surfaces of the polygon mirror 110 which is provided at the scanning/exposing section 20A of the image forming section corresponding to the color material color j, a single reflecting surface, for which formation of a pattern for misregistration detection which will be described later has not yet been carried out, is selected as the object of misregistration detection. Then, in step 154, the pattern for misregistration detection is formed by only the light beams which are reflected by the reflecting surface which is the object of misregistration detection which was selected in step 152, by the image forming section corresponding to the color material color j.

Namely, the rotational position detecting sensor 114 is connected to the control section 80, and a detection signal, in which a predetermined period level changes each time the polygon mirror 110 comes to a specific rotational angle, is inputted from the rotational position detecting sensor 114. Therefore, on the basis of a reflecting surface sensing signal, which is obtained by frequency-dividing the inputted detection signal by using the timing at which the level of that signal changes as a reference, the control section 80 senses the rotational angle of the polygon mirror 110, i.e., which of the reflecting surfaces is reflecting the light beam. Then, each time that the interval when the reflecting surface, which is the object of misregistration detection selected in step 152, reflects the light beam arrives, all of the light-emitting portions of the VCSEL 100 of the scanning/exposing section 20A being made to emit light, and data which forms a linear pattern at the SOS side end portion and the EOS side end portion of the image region being outputted to the image forming section corresponding to the color material color j, are repeated a predetermined number of times. In this way, the striped pattern for misregistration detection shown in FIG. 6B as an example is formed at each of the SOS side end portion and the EOS side end portion as shown in FIG. 6A. Note that the pattern for misregistration detection shown in FIG. 6B is shown as a pattern formed by a reflecting surface C among eight reflecting surfaces A through H provided at the polygon mirror 110.

In subsequent step 156, it is judged whether or not the above-described formation of the pattern for misregistration has been carried out for all of the reflecting surfaces of the polygon mirror 110. If this judgment is negative, the control returns to step 152, and steps 152 through 156 are repeated until the judgment of step 156 is affirmative. In this way, plural patterns for misregistration detection, which are formed by light beams which are reflected and deflected at respectively different reflecting surfaces of the polygon mirror 110, are respectively formed on the peripheral surface of the photosensitive body 20C of the image forming section corresponding to the color material color j, and these patterns for misregistration detection are respectively transferred onto the intermediate transfer belt 30.

When the judgment of step 156 is affirmative, the routine moves on to step 158. As shown in FIG. 6C as well, when, as the intermediate transfer belt 30 moves, the place where, among the patterns for misregistration detection corresponding to the respective reflecting surfaces and transferred onto the intermediate transfer belt 30, a pattern for misregistration detection (the pattern for misregistration detection of the specific reflecting surface) is transferred reaches the position where the detecting units of the pattern detecting section 28 are disposed, the pattern for misregistration detection of the specific reflecting surface, which has reached the position where the detecting units are disposed, is read by the detecting units. Each of the patterns for misregistration detection is formed only by the light beam reflected and deflected by a single reflecting surface among the plural (8 in the present exemplary embodiment) reflecting surfaces provided at the polygon mirror 110. Therefore, although the density (coverage) thereof is 12.5% which is relatively low, the individual lines in the striped pattern for misregistration detection are formed by 32 light beams and the width of each line is 0.34 mm. Therefore, detection of the pattern for misregistration detection is sufficiently possible.

In step 160, on the basis of the results of reading the pattern for misregistration detection by the detecting unit positioned at the SOS position, the misregistration amount of the position of the pattern for misregistration detection with respect to a reference position of the SOS side (i.e., the end portion position of the image region at the SOS side) is computed. On the basis of the computed misregistration amount, a modulating start timing correction value of the light beams, which is for making the end portion position of the image region at the SOS side coincide with the reference position at the SOS side, is set. For example, in a case in which the number of pulses of a video clock are counted from a given reference timing and modulation of the light beams is started when the count value of the number of pulses becomes a stipulated value corresponding to 100 pixels, if it is detected that the pattern for misregistration detection is shifted toward the SOS side by 10 μm (=1 pixel), it suffices to set a correction value, which changes the stipulated value to a value corresponding to 101 pixels, as the modulation start timing correction value. In this way, due to the end portion position of the image region at the SOS side being moved 10 μm toward the EOS side, it is made to coincide with the reference position at the SOS side. Then, in step 160, the set modulation start timing correction value is stored in the memory 142 in correspondence with information which identifies the color material color j and information (e.g., a reflecting surface number or the like) which identifies the specific reflecting surface corresponding to the pattern for misregistration detection for which reading was carried out.

In step 162, on the basis of the results of reading the pattern for misregistration detection by the detecting unit positioned at the EOS position, the misregistration amount of the position of the pattern for misregistration detection with respect to a reference position of the EOS side (i.e., the end portion position of the image region at the EOS side) is computed. Next, the misregistration amount of the length of the image region is computed from the computed misregistration amount of the end portion position of the image region at the EOS side and the misregistration amount of the end portion position of the image region at the SOS side which was computed in step 160. A number of pixels to be added/deleted, which is for making the end portion position of the image region at the EOS side coincide with the reference position at the EOS side by correcting the misregistration of the length of the image region, is set.

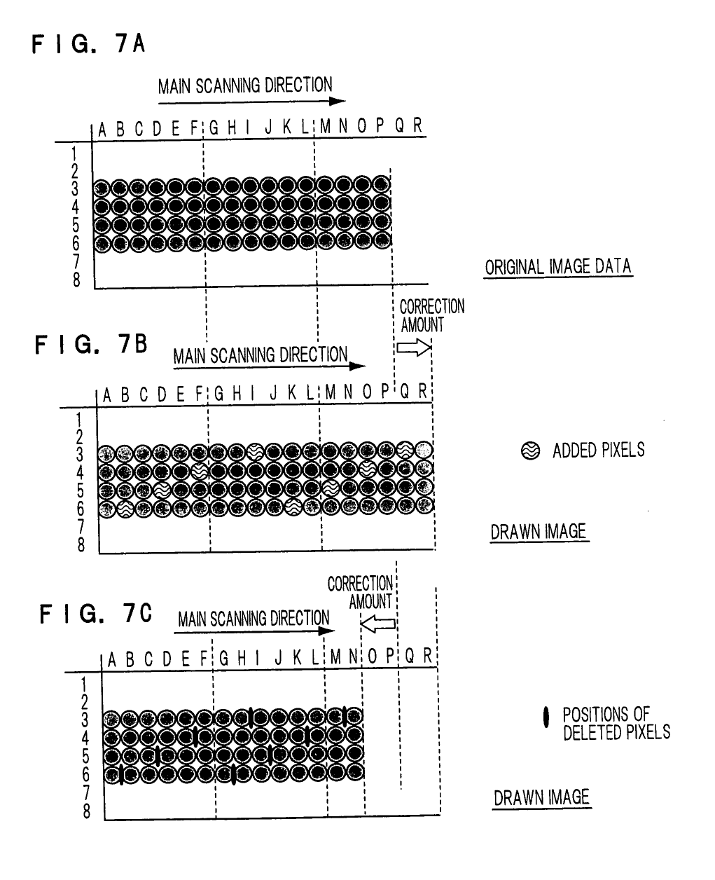

In a case in which, with respect to the original image data shown in FIG. 7A, the same number of pixels are added to each main scan line as shown in FIG. 7B, the lengths of the respective main scan lines (the length of the image region) become longer by the number of added pixels, and accompanying this, the end portion position of the image region at the EOS side also moves toward the EOS side by an amount corresponding to the number of added pixels. Further, in a case in which the same number of pixels are deleted from each of the main scan lines as shown in FIG. 7C, the lengths of the respective main scan lines (the length of the image region) become shorter by the number of deleted pixels, and accompanying this, the end portion position of the image region at the EOS side also moves toward the SOS side by an amount corresponding to the number of deleted pixels. In the present exemplary embodiment, by carrying out addition or deletion of pixels as described above on the data used in modulating the light beams, the length of the image region is corrected, and the end portion position of the image region at the EOS side is made to coincide with the reference position at the EOS side. The processing itself of this correction is extremely simple as compared with control which changes the frequency of a video clock at each main scan. Further, the changing of the correction amount is achieved by only changing the number of pixels to be added or deleted. Therefore, it is possible to carry out control to a desired magnification (i.e., make the image region be a desired length) at each of the main scan lines.

Note that the resolution of the correction in the above-described correcting processing is one pixel unit, and is 10 μm (more correctly, 10.58 μm) at 2400 dpi. For example, in the example shown in FIG. 7B, the end portion position of the image region at the EOS side is moved by two pixels, i.e., 20 μm, toward the EOS side. In the example shown in FIG. 7C, the end portion position of the image region at the EOS side is moved by two pixels (20 μm) toward the SOS side. Accordingly, the number of pixels to be added/deleted can be determined by dividing the computed misregistration amount of the length of the image region by the pixel interval (e.g., 10 μm). Then, in step 162, the set number of pixels to be added/deleted is stored in the memory 142 in correspondence with information identifying the color material color j and information (e.g., the reflecting surface number or the like) identifying the specific reflecting surface corresponding to the pattern for misregistration detection for which reading was carried out.

In next step 164, it is judged whether or not the above-described reading of the pattern for misregistration detection and setting and storing of the correction values (the modulation start timing correction value and the number of pixels to be added/deleted) has been carried out for all of the reflecting surfaces of the polygon mirror 110. If the judgment is negative, the control returns to step 158, and step 158 through step 164 are repeated until the judgment of step 164 is affirmative. In this way, the setting and storing of the correction values is carried out respectively for all of the reflecting surfaces of the polygon mirror 110 of the image forming section corresponding to the color material color j. When the judgment of step 164 is affirmative, the control moves on to step 166 where it is judged whether or not the above-described processings have been carried out for each of the respective color material colors of Y, M, C, K. If the judgment is negative, the control returns to step 150, and step 150 through step 166 are repeated until the judgment of step 166 is affirmative. When the judgment of step 166 is affirmative, the correction value setting processing ends.

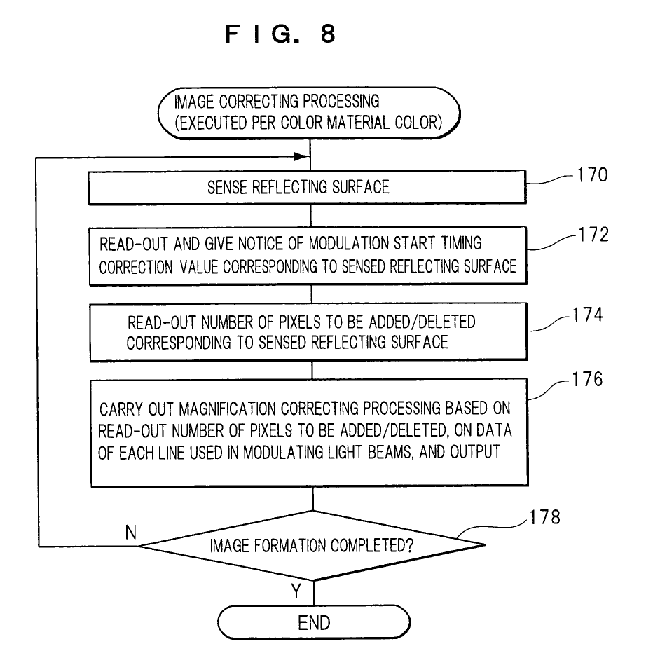

Next, image correcting processing, which is realized by the control section 80 executing an image correcting program, will be described with reference to FIG. 8. This image correcting processing is processing corresponding to the registration correcting processing section 134. The image correcting processings corresponding to the respective color material colors (the individual image forming sections) are executed in parallel at the time of forming a color image.

In the image correcting processing corresponding to the specific color material color j, in step 170, on the basis of the reflecting surface sensing signal which is generated on the basis of the detection signal inputted from the rotational position detecting sensor 114 of the image forming section corresponding to the specific color material color j, the reflecting surface which reflects and deflects the light beams in the main scan of the next period at the image forming section is sensed. In next step 172, the modulation start timing correction value, which corresponds to the specific color material color j and the reflecting surface sensed in step 170, is read-out from the memory 142, and the image printing processing section 136 is notified of the read-out modulation start timing correction value. As shown in FIG. 3D, the modulation start timings of the 32 light beams emitted from the VCSEL 100 are made to differ in accordance with the misregistration of the illuminated positions on the photosensitive body 20C along the main scanning direction. The image printing processing section 136 carries out the processing of changing (correcting) the modulation start timings of the individual light beams of the next period in accordance with the notified modulation start timing correction value. In this way, the end portion positions at the SOS side of the image regions on the main scan lines formed respectively by the 32 light beams in the next period, are respectively made to coincide with the SOS side reference position.

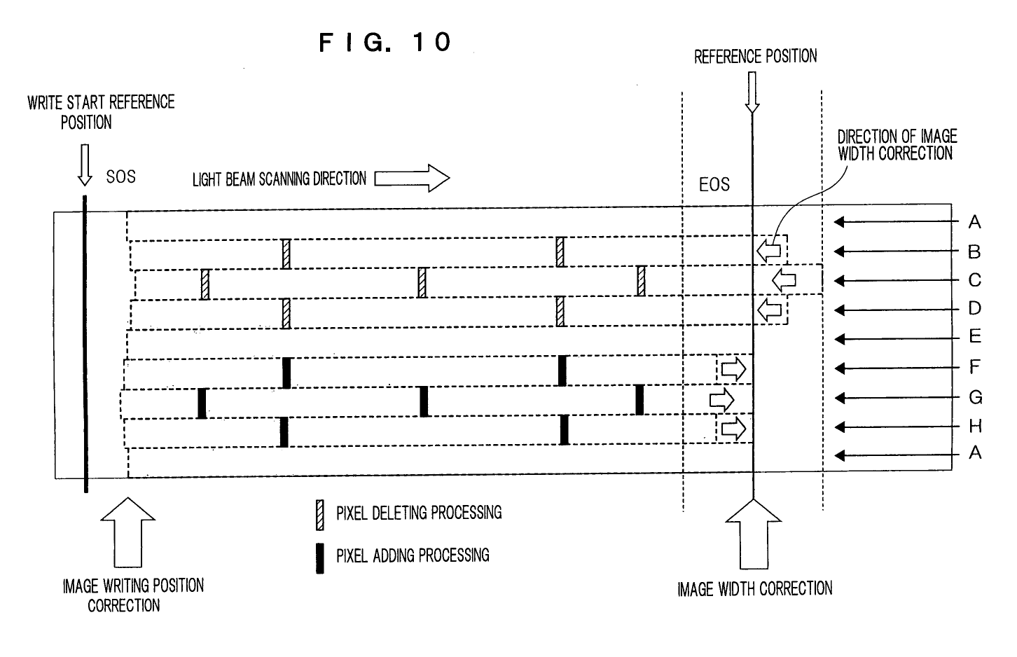

In next step 174, the number of pixels to be added/deleted, which corresponds to the specific color material color j and the reflecting surface sensed in step 170, is read-out from the memory 142. Then, in step 176, magnification correcting processing, which adds or deletes a number of pixels corresponding to the number of pixels to be added/deleted which was read-out in step 174, is carried out on the data (the unit data in the present invention) of the 32 main scan lines used in modulating the 32 light beams emitted from the VCSEL 100 of the image forming section corresponding to the specific color material color j in the main scan of the next period. The data of the respective lines, on which this magnification correcting processing has been carried out, is outputted to the image printing processing section 136. Note that it is preferable that the positions at which the adding or deleting of pixels is carried out are set (see FIG. 10 as well) such that, for example, if the number of pixels to be added/deleted is one, the addition or deletion is carried out at the center of each line, and if the number of pixels to be added/deleted is plural, the addition or deletion positions of the pixels are positioned uniformly in each line. Further, it suffices to use a value, which is the same as the pixel value of the pixel existing originally at the addition position, as the pixel value of the pixel to be added. In this way, the modulation of the 32 light beams in the next period is carried out in accordance with data which has undergone the above-described magnification correcting processing, and the lengths of the image regions on the main scan lines formed by the 32 light beams in the next period are thereby respectively made to coincide with the reference length. In this way, the end portion positions at the SOS side of the image regions on the main scan lines are respectively made to coincide with the SOS side reference position.

In next step 178, it is judged whether or not image formation at the image forming section corresponding to the specific color material color j has been completed. If the judgment is negative, the control returns to step 170, and step 170 through step 178 are repeated until the judgment of step 178 is affirmative. Here, each time the judgment of step 178 is negative and the control returns to step 170, a reflecting surface which is different than that the last time is sensed as the reflecting surface which reflects and deflects the light beams in the main scan of the next period. Therefore, with regard to the modulation start timing correction value read-out from the memory 142 in step 172 and the number of pixels to be added/deleted read-out from the memory 142 in step 174, data which correspond to a reflecting surface which is different than that the last time are read-out, and correction which corresponds to the reflecting surface which reflects and deflects the light beams in the main scan of the next period is carried out.

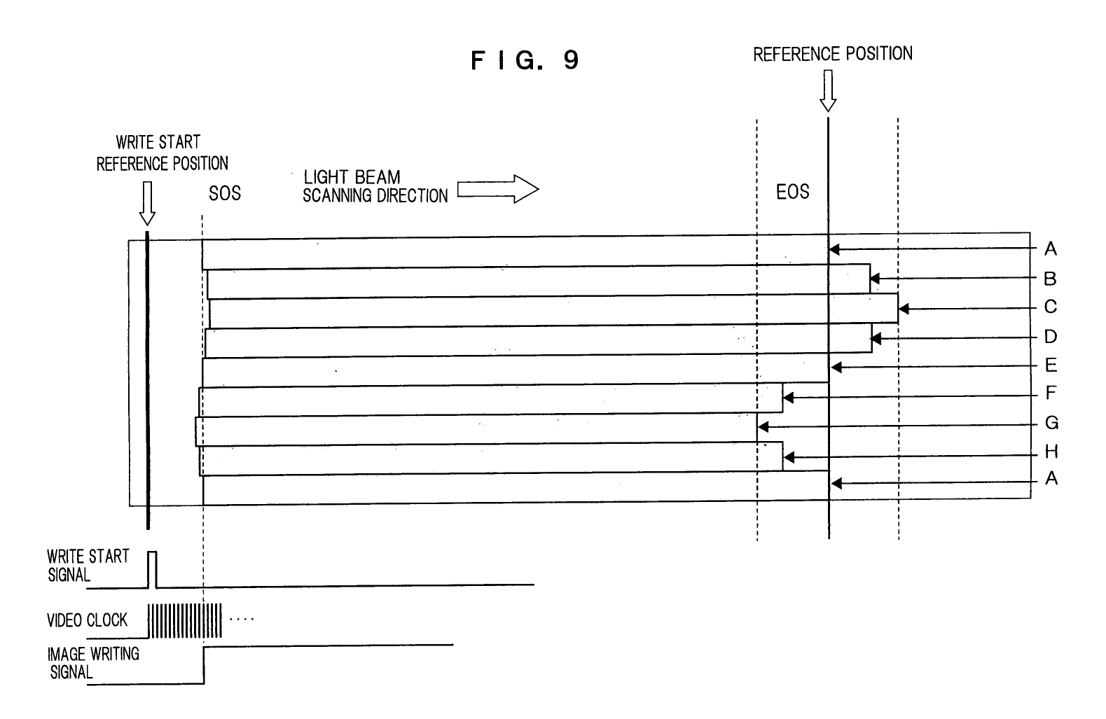

The above-described correction will be described further with reference to the drawings. The variation in the end portion positions of the image regions at the SOS side and the EOS side shown in FIG. 3C is shown in an enlarged manner in FIG. 9. The plural, planar, rectangular regions shown in FIG. 9 show the image regions formed by 32 light beams in one main scan. The letters A through H assigned to the individual image regions express the reflecting surface which deflects and reflects the 32 light beams at the time of forming each region, among the eight reflecting surfaces of the polygon mirror 110. As is clear from FIG. 9 as well, due to variation within the tolerance of each reflecting surface of the polygon mirror 110 or fluctuations in the rotating speed of the polygon mirror 110, the SOS side and EOS side end portion positions of the image regions which are formed successively are respectively dispersed, with one rotation of the polygon mirror 110 being one period. The modulating of the light beams is started after a predetermined period of time elapses, triggered by a signal from a write start reference position sensor which is disposed outside of the image forming region (i.e., modulation is started at the point in time when the count value of the number of pulses of a video clock has become a stipulated value). Therefore, the fluctuations in the end portion positions of the image regions at the SOS side, which is near to the position at which the write start reference position sensor is disposed, are relatively small. On the other hand, the end portion positions of the image regions at the EOS side, which is far from this sensor, fluctuate greatly.

Here, with the end portion positions of the image region corresponding to reflecting surface A as the references, the end portion positions of the image regions corresponding to the respective reflecting surfaces fluctuate ±5 μm at the SOS side and ±30 μm at the EOS side. Namely, with respect to the EOS side end portion position of the image region corresponding to reflecting surface A, the EOS side end portion positions of the image regions corresponding to reflecting surfaces B, D are shifted toward the EOS side by 20 μm, the EOS side end portion position of the image region corresponding to reflecting surface C is shifted toward the EOS side by 30 μm, the EOS side end portion positions of the image regions corresponding to the reflecting surfaces F, H are shifted toward the SOS side by 20 μm, and the EOS side end portion position of the image region corresponding to the reflecting surface G is shifted toward the SOS side by 30 μm. In this case, in the previously-described correction value setting processing (FIG. 5), the number of pixels to be added/deleted is set to “delete two pixels” for reflecting surfaces B, D, “delete three pixels” for reflecting surface C, “add two pixels” for reflecting surfaces F, H, and “add three pixels” for reflecting surface G.

Results of carrying out magnification correcting processing (addition or deletion of pixels) in the image correcting processing (FIG. 8) corresponding to these numbers of pixels to be added/deleted are shown in FIG. 10. As shown in FIG. 10, when the light beams are reflected and deflected at the reflecting surfaces B, D, modulation of the light beams is carried out in accordance with data from which data of two pixels has been deleted. When the light beams are reflected and deflected at the reflecting surface C, modulation of the light beams is carried out in accordance with data from which data of three pixels has been deleted. When the light beams are reflected and deflected at the reflecting surfaces F, H, modulation of the light beams is carried out in accordance with data to which data of two pixels has been added. When the light beams are reflected and deflected at the reflecting surface G, modulation of the light beams is carried out in accordance with data to which data of three pixels has been added. By repeating the carrying out of modulation in this way, the jitter is corrected, and the EOS side end portion positions of the image regions corresponding to the respective reflecting surfaces match the reference position.

Note that, in the examples shown in FIGS. 9 and 10, because the misregistration amounts of the SOS end portion positions of the image regions corresponding to the respective reflecting surfaces are less than the resolution (10 μm) of correction in the correcting of the light beam modulation start timing, correcting of the light beam modulating start timing is not carried out. However, it is also possible to correct the misregistration of the SOS end portion positions of the image regions at a resolution which is less than the pixel interval (=10 μm), if the video clock phase is controlled by using a clock which is two or more times the video clock. If such correction is applied, even if the misregistration amounts of the SOS end portion positions are less than the pixel interval, the SOS end portion positions of the image regions can be made uniform as shown in FIG. 10. (As compared with a case in which frequency modulation is carried out by using a high frequency clock, phase control using a high frequency clock is easy, and it is possible to avoid making the structure complex.)

The above describes a case in which the correction relating to the present invention (correction of misregistration along a predetermined direction (the main scanning direction) of the image regions by correcting image data) is applied only to correction with respect to (fluctuations in the EOS side end portion positions of the image regions which vary in accordance with) fluctuations in the lengths of the image regions. However, the present invention is not limited to the same. The correction relating to the present invention may of course also be applied to correction with respect to fluctuations of the SOS side end portion positions of the image regions. Hereinafter, an example in which fluctuations of the SOS side end portion positions of the image regions are corrected by correcting image data will be described.

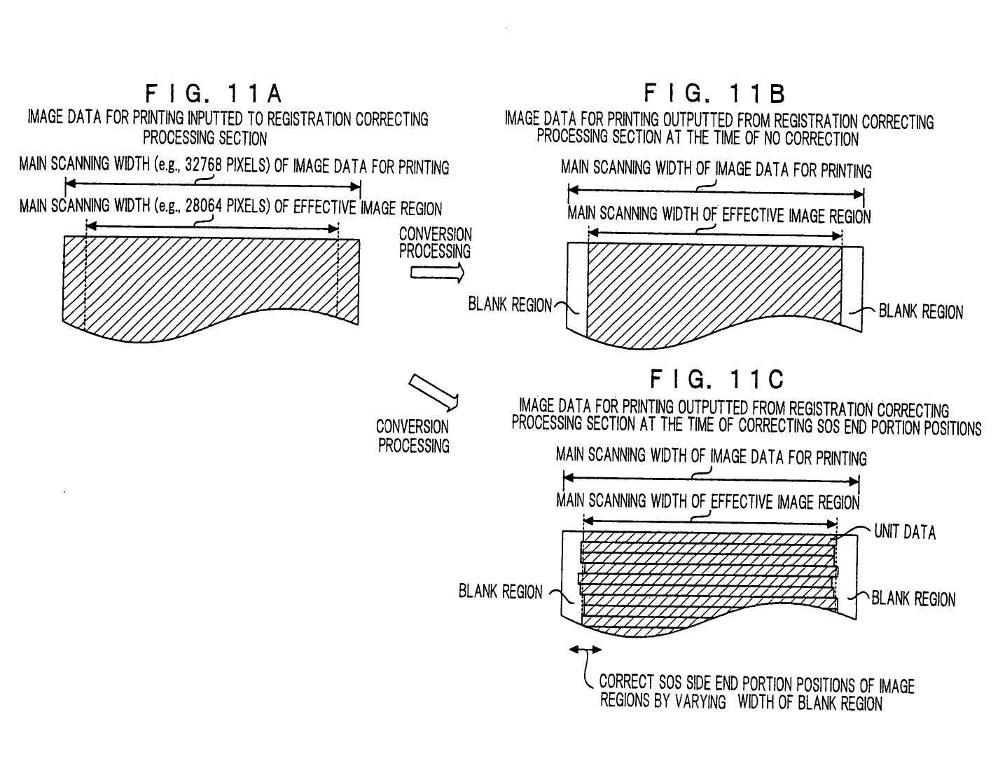

In this example, as shown as an example in FIG. 11A, image data (corresponding to original image data), whose number of pixels in the main scanning direction is greater than the number of pixels in the main scanning direction of an effective image region corresponding to an image to actually be formed on a sheet, is inputted to the registration correcting processing section 134 as image data for printing. As an example, in a case in which the width in the main scanning direction of an image which is to actually be formed on a sheet is 297 mm and the resolution in the main scanning direction is 2400 dpi, the number of pixels in the main scanning direction of the effective image region is 28064 (=the minimum even number satisfying 297 mm÷25.4×2400). The number of pixels in the main scanning direction of the image data for printing is, for convenience of processing, desirably a number obtained by raising two to some power, and therefore, can be made to be 32768 pixels for example.

In a case in which correction of the SOS side end portion positions of the image regions is not to be carried out, the registration correcting processing section 134 sets an effective image region at a predetermined position (e.g., the center) along the main scanning direction with respect to the inputted image data for printing, and carries out conversion processing which replaces, among the respective pixels of the inputted image data for printing, all of the pixels outside of the set effective image region (pixels which are “outside of the range corresponding to the image region” ), with blank pixels (pixels whose respective Y, M, C, K color densities are all 0). In this way, as shown in FIG. 11B as an example, blank regions which are formed from only blank pixels are formed at the main scanning direction both end portions of the image data for printing. Then, magnification correcting processing (the addition or deletion of pixels) corresponding to the numbers of pixels to be added/deleted is carried out on the image data for printing after the conversion processing, and thereafter, the data is outputted to the image printing processing section 136.

In a case in which, as a result of carrying out formation and reading of the patterns for misregistration detection as described previously, the positions of the patterns for misregistration detection are shifted with respect to the SOS side reference position, the registration correcting processing section 134 senses the direction of the misregistration and the misregistration amount of each of the reflecting surfaces of the polygon mirror 110, and converts the sensed misregistration amounts into numbers of pixels. Then, with the data (unit data) of the 32 main scan lines used in modulating the 32 light beams emitted from the VCSEL 100 being a unit, conversion processing is carried out on the image data for printing after the effective image region is set for each of the unit data, such that the positions of the effective image regions on the image data for printing are shifted by the converted numbers of pixels in the directions opposite to the sensed directions of misregistration for the reflecting surfaces corresponding to the polygon mirror 110. In this way, as shown as an example in FIG. 11C, for each of the individual unit data, the width (number of pixels) along the main scanning direction of the blank region at the SOS side (and the EOS side) is increased/decreased in accordance with the direction of positional misregistration and the misregistration amount of the pattern for misregistration direction with respect to the SOS side reference position.

In this example, modulation start timing correction values are not outputted from the registration correcting processing section 134 to the image printing processing section 136, and the image printing processing section 136 starts modulation of the light beams at a fixed timing in the main scan of each time. However, during the time when the data used in modulating the light beams is data of the pixels within the blank regions, light beams are not emitted from the VCSEL 100. Therefore, the timing at which the emitting of the light beams from the VCSEL 100 is started in the main scan of each time is switched per reflecting surface of the polygon mirror 110. The variation in the end portion position of the image region per main scan line at the SOS side is corrected.

Further, an example is described above in which the correction, per unit data, of the image data, and the image formation based on the corrected image data (the modulating of the light beams) are carried out in parallel. However, the present invention is not limited to the same, and it is possible to carry out image formation after the correction of the image data has been completed.

The above describes an example in which, other than at the time when the color image forming device 10 is manufactured, at the time when the color image forming device 10 is set-up, and at times when the structural parts of the color image forming device 10 are replaced, the correction value setting processing shown in FIG. 5 is executed, for example, in a case in which the accumulated working time from the time that the correction value setting processing was last executed has reached a predetermined time. However, the present invention is not limited to the same. The period of executing (i.e., the operation frequency of) the correction value setting processing may be determined in consideration of at least one main cause of the jitter varying, e.g., fluctuations in the internal temperature of the scanning/exposing section 20A or the machine internal temperature of the image forming device 10, the rotational driving time of the polygon mirror 110, the accumulated value of the number of images formed by the image forming device 10 (the accumulated value of the number of outputted prints), or the like, and the correction value setting processing may be executed at the determined executing period.

An example is described above in which the pattern for misregistration detection formed on the intermediate transfer belt 30 is detected by the detecting units of the pattern detecting section 28, and the misregistration amount is detected. However, the present invention is not limited to the same, and the pattern for misregistration detection or a pattern similar thereto may be formed and outputted onto the sheet 50, and the misregistration amount may be detected by an online or an offline scanner, or by the naked eye, or the like. With such a structure, the above-described technique can also be applied to image forming devices which do not have an intermediate transfer body such as the intermediate transfer belt 30, and which successively transfer toner images which are on a photosensitive body onto a sheet which is carried by a sheet carrier.

Further, the above describes an example in which the positional misregistration of the image region end portions at the SOS side, and the variation in the lengths of the image regions (the positional misregistration of the end portions of the image regions at the EOS side) are respectively corrected. However, an example in which only either one is corrected also falls within the scope of the present invention. In particular, an example which detects and corrects only the variation in the lengths of the image regions (the positional misregistration of the end portions of the image regions at the EOS side) achieves the effect of an improvement in image quality which can easily be confirmed visually.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming device comprising:
a rotating polygon mirror; and
a correcting component correcting that corrects misregistration of an image region in a predetermined direction by correcting image data used in modulating light beams reflected and deflected by any one reflecting surface among a plurality of reflecting surfaces provided at the rotating polygon mirror, the light beams scanning a body-to-be-illuminated in the predetermined direction, correcting image data by each data unit used in modulating light beams which are reflected and deflected at the same reflecting surface, and correcting image data in accordance with a misregistration amount in the predetermined direction of the image region formed on the body-to-be-illuminated by the light beams which are reflected and deflected, the misregistration amount being measured in advance for each reflecting surface of the rotating polygon mirror.

2. The image forming device of claim 1, wherein the correcting component corrects misregistration of an end portion position of the image region in the predetermined direction by generating image data used in modulating the light beams by carrying out conversion processing on original image data expressing an original image whose number of pixels in the predetermined direction is greater than a number of pixels corresponding to an image region, the conversion processing replacing pixels outside of a range corresponding to the image region with blank pixels, and the conversion processing correcting by each data unit a position in the predetermined direction of the range corresponding to the image region in accordance with a misregistration amount of the end portion position of the image region in the predetermined direction, the misregistration amount being measured in advance for each reflecting surface of the rotating polygon mirror.

3. The image forming device of claim 1, wherein the correcting component corrects misregistration in a length of the image region in the predetermined direction by correcting for the image data a number of pixels per line by carrying out addition or deletion of pixels in accordance with a misregistration amount of the length of the image region in the predetermined direction, the correction being carried out by each data unit, and the misregistration amount being measured in advance for each reflecting surface of the rotating polygon mirror.

4. The image forming device of claim 1 further comprising a reflecting surface detecting component that detects the reflecting surface among the plurality of reflecting surfaces that reflect and deflect the light beams, wherein
on the basis of results of detection of the reflecting surface by the reflecting surface detecting component, the correcting component determines which of the individual data units structuring the image data are used in modulation of light beams reflected and deflected by which of the plurality of reflecting surfaces.

5. The image forming device of claim 1 further comprising a memory which stores correction data for each reflecting surface for correcting misregistration of the image region in the predetermined direction, the correction data being set based on results of measuring a misregistration amount of the image region in the predetermined direction for each reflecting surface of the rotating polygon mirror, wherein
the correcting component carries out correction of the image data by each data unit on the basis of the correction data for each reflecting surface stored in the memory.

6. The image forming device of claim 5 further comprising:
a measuring component that measures for each of the plurality of reflecting surfaces of the rotating polygon mirror a misregistration amount in the predetermined direction of an image region formed on the body-to-be-illuminated by light beams reflected and deflected by each of the plurality of reflecting surfaces of the rotating polygon mirror; and
a correction data setting component that sets correction data for correcting misregistration of the image region in the predetermined direction for each of the plurality of reflecting surfaces on the basis of the misregistration amount in the predetermined direction of the image region measured for each of the plurality of reflecting surfaces by the measuring component, and stores the set correction data for each of the plurality of reflecting surfaces in the memory.

7. The image forming device of claim 6 further comprising a first controller which causes measuring of the misregistration amount of the image region in the predetermined direction by the measuring component and setting of the correction data by the correction data setting component to be executed at least at a time selected from a time of manufacturing the image forming device, a time of setting-up the image forming device, and a time of replacing structural parts of the image forming device.

8. The image forming device of claim 6 further comprising:
a sensor that senses at least one of a device internal temperature of the image forming device, a rotating time of the rotating polygon mirror, and an accumulated value of a number of images formed by the image forming device; and
a second controller which causes the measuring of the misregistration amount of the image region in the predetermined direction by the measuring component and the setting of the correction data by the correction data setting component to be executed periodically at a period that depends on at least one of the device internal temperature of the image forming device, the rotating time of the rotating polygon mirror, and the accumulated number of images formed by the image forming device, sensed by the sensor.

9. An image forming device comprising:
a light scanning device having a rotating polygon body that has a plurality of reflecting surfaces;
a body-to-be-scanned that is scanned in a predetermined direction by light beams reflected and deflected by the plurality of reflecting surfaces of the rotating polygon body;
a measuring component that measures for each of the plurality of reflecting surfaces of the rotating polygon body a misregistration amount in the predetermined direction of an image region formed on the body-to-be-scanned by scanning of the light beams; and
a correcting component that corrects in accordance with the measured misregistration amounts image data corresponding to the respective reflecting surfaces of the rotating polygon body, the image data being used in modulating the light beams.

10. The image forming device of claim 9, wherein the correcting component corrects the image data by each data unit used in modulating the light beams.

11. The image forming device of claim 9, wherein the correcting component corrects the image data by phase control using a high frequency clock.

12. A method of correcting an image to be formed, wherein
a misregistration of an image region in a predetermined direction is corrected by correcting image data used in modulating light beams reflected and deflected by any one reflecting surface among a plurality of reflecting surfaces provided at a rotating polygon mirror, the light beams being scanned in the predetermined direction on a body-to-be-illuminated, correcting image data by each data unit used in modulating light beams which are reflected and deflected at the same reflecting surface, correcting image data in accordance with a misregistration amount in the predetermined direction of the image region formed on the body-to-be-illuminated by the light beams which are reflected and deflected, the misregistration amount being measured in advance for each reflecting surface of the rotating polygon mirror.

13. An image correcting method comprising:
measuring, for each of a plurality of reflecting surfaces of a rotating polygon body of a light scanning device, a misregistration amount in a predetermined direction of an image region formed on a body-to-be-scanned by light beams reflected and deflected by the plurality of reflecting surfaces; and
correcting, in accordance with measured misregistration amounts, image data used in modulating the light beams corresponding to each of the respective reflecting surfaces of the rotating polygon body.

14. The image correcting method of claim 13, wherein the image data used in modulating the light beams is corrected by each data unit used in modulation.

15. The image correcting method of claim 13, wherein the image data used in modulating the light beams is corrected by phase control using a high frequency clock.
